(19) United States
(12) Patent Application Publication
(10) Pub. No.: US 2012/0013944 A1
(43) Pub. Date: Jan. 19, 2012

(54) INFORMATION PROCESSING APPARATUS, DISPLAY CONTROL METHOD, AND STORAGE MEDIUM STORING PROGRAM THEREOF

(75) Inventors: Jun Ehara, Yokohama-shi (JP); Masakazu Nomoto, Yokohama-shi (JP)

(73) Assignee: CANON KABUSHIKI KAISHA, Tokyo (JP)

(21) Appl. No.: 13/153,700

(22) Filed: Jun. 6, 2011

(30) Foreign Application Priority Data
Jul. 16, 2010 (JP) 2010-162211

(51) Int. Cl. G06K 15/00

(52) U.S. Cl. 358/1.15

(57) ABSTRACT

Print data containing a plurality of contents is input, and it is determined whether printing of each of the plurality of contents contained in the input print data is permitted. The user is notified of the determination result before an instruction to print the print data.

### BACKGROUND OF THE INVENTION

1. Field of the Invention

The present invention relates to an information processing apparatus which processes print data containing a plurality of contents, a display control method in the information processing apparatus, and a storage medium storing a program thereof.

2. Description of the Related Art

There has been conventionally known a technique of setting printing permission information for contents such as image data. The printing permission information permits execution of print processing to protect the use of an image for which the content data creator or the like has the copyright of its content data, and the use of pay digital contents. There is known a technique of determining, based on permission information of print processing or the like for such content data, whether execution of processing for the content data is inhibited, and when it is determined that execution of processing is inhibited, notifying the user of a message to this effect (Japanese Patent Laid-Open No. 2004-282384).

However, according to the technique in Japanese Patent Laid-Open No. 2004-282384, the user knows that printing is inhibited only after he issues a printing instruction, and whether printing is permitted cannot be determined before issuing a printing instruction. Also, this technique does not consider printing of print data containing a plurality of contents. When handling such print data, printing may start if, for example, printing of the contents of the first page is permitted.

### SUMMARY OF THE INVENTION

An aspect of the present invention is to eliminate the above-mentioned problems with the conventional technology. The present invention provides an information processing apparatus which can notify the user whether printing is permitted before issuing a printing instruction when printing print data containing a plurality of contents, thereby improving user friendliness, a display control method in the information processing apparatus, and a storage medium storing a program thereof.

The present invention in its first aspect provides an information processing apparatus which processes print data to be printed by a printing apparatus, comprising: an input unit configured to input print data containing a plurality of contents; a determination unit configured to determine whether printing of each of the plurality of contents contained in the print data input by the input unit is permitted; and a notification unit configured to notify a user of a result of a determination by the determination unit before the print data is instructed to print.

The present invention in its second aspect provides a display control method executed in an information processing apparatus which processes print data to be printed by a printing apparatus, comprising the steps of: inputting print data containing a plurality of contents; determining whether printing of each of the plurality of contents contained in the input print data is permitted; and notifying a user of a result of the determination before an instruction to print the print data.

The present invention in its third aspect provides a non-transitory computer-readable storage medium storing a program for causing a computer to input print data containing a plurality of contents, determine whether printing of each of the plurality of contents contained in the input print data is permitted, and notify a user of a result of the determination before an instruction to print the print data.

According to the present invention, information about whether printing of print data containing a plurality of contents is permitted can be provided before the start of printing, thereby improving user friendliness.

Further features of the present invention will become apparent from the following description of exemplary embodiments with reference to the attached drawings.

### BRIEF DESCRIPTION OF THE DRAWINGS

FIG. 1 is a block diagram showing an example of the hardware configuration of an information processing apparatus;

FIG. 2 is a block diagram showing the software configuration of a printing application;

FIG. 3 is a table showing an example of a content database;

FIGS. 4A and 4B are views each showing an example of a document created by the user using the printing application;

FIG. 5 is a view showing an example of a screen by the printing application;

FIG. 6 is a flowchart showing a processing sequence of displaying a document file in the first embodiment;

FIG. 7 is a view showing another example of a document created by the user using the printing application;

FIG. 8 is a view showing another example of a screen by the printing application;

FIG. 9 is a flowchart showing a processing sequence of displaying a document file in the second embodiment;

FIG. 10 is a block diagram showing the software configurations of a preview generation module, file list application, and printing application;

FIG. 11 is a view showing an example of the internal structure of a document file;

FIGS. 12A and 12B are views each showing another example of a document created by the user using the printing application;

FIG. 13 is a view showing an example of the screen display of a file list application in the third embodiment;

FIGS. 14A and 14B are flowcharts showing the processing sequence of a preview generation module in the third embodiment;

FIG. 15 is a table showing a state in which the content database shown in FIG. 3 is updated;

FIG. 16 is a view showing an example of the screen display of a file list application in the fourth embodiment;

FIG. 17 is a flowchart showing the processing sequence of a preview generation module in the fourth embodiment; and

FIG. 18 is a flowchart showing a processing sequence of calculating printing permission information about a printing-permitted page.

### DESCRIPTION OF THE EMBODIMENTS

Preferred embodiments of the present invention will now be described hereinafter in detail, with reference to the accompanying drawings. It is to be understood that the following embodiments are not intended to limit the claims of the present invention, and that not all of the combinations of the aspects that are described according to the following embodiments are necessarily required with respect to the means to solve the problems according to the present invention. Note that the same reference numerals denote the same parts, and a repetitive description thereof will be omitted.

### First Embodiment

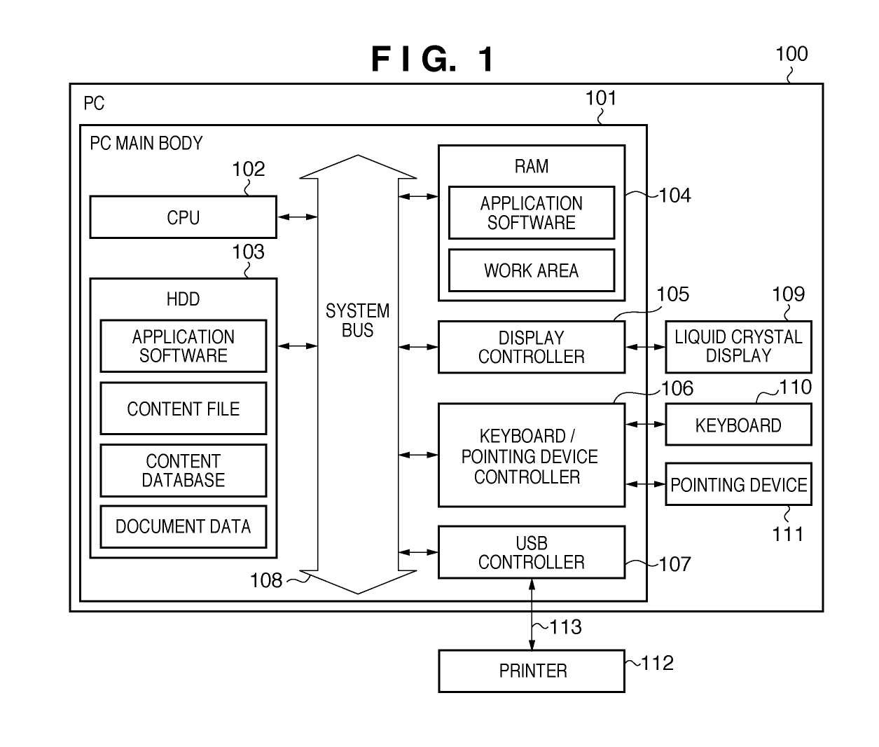

FIG. 1 is a block diagram showing an example of the hardware configuration of an information processing apparatus according to the first embodiment of the present invention. The information processing apparatus in FIG. 1 is, for example, a PC (Personal Computer). A PC 100 includes a PC main body 101, liquid crystal display 109, keyboard 110, and pointing device 111. The PC main body 101 includes a CPU 102, hard disk drive (HDD) 103, RAM 104, display controller 105, keyboard/pointing device controller 106, and USB controller 107. A system bus 108 connects the CPU 102, HDD 103, RAM 104, display controller 105, keyboard/pointing device controller 106, and USB controller 107 to each other. A printer 112 is connected to the PC 100 via a USB cable 113. The printer 112 receives image data from the PC 100, and prints an image based on the image data on a printing medium such as printing paper. The PC 100 can be a general-purpose one.

The CPU 102 reads out software loaded into the RAM 104 and executes it to control the respective units in the PC main body 101 and implement the function of the readout software. The HDD 103 stores application software, image data (content file) serving as contents to be used by the application software, a content database, and the like. The HDD 103 also stores an operating system (OS) for the PC 100 and a device driver for the printer 112. Each of software and data in the HDD 103 is stored in the form of a file. The HDD 103 allows creating a folder in it, and the folder can contain a file or another folder. In the HDD 103, therefore, a folder-based hierarchical structure is built.

Application software stored in the HDD 103 is loaded into the RAM 104. A work area used when the CPU 102 executes each software is also ensured in the RAM 104. The display controller 105 controls the liquid crystal display 109 to display a text and image on the liquid crystal display 109. The keyboard/pointing device controller 106 accepts an input from the user via the keyboard 110 or pointing device 111. The system bus 108 connects the respective units in the PC main body 101 to each other, and transfers various data.

In the first embodiment, the PC 100 includes the liquid crystal display 109 as a display device, but another type of display device is also available, including a cathode ray tube display or plasma display. The PC 100 includes the keyboard 110 and pointing device 111 as input devices, but another type of input device is also available, including a touch panel or trackball. The connection interface between the PC 100 and the printer 112 is a USB interface, but another communication technique such as IEEE802.11 or 100 Base TX is also usable.

In the above arrangement, to make the PC 100 function as the information processing apparatus in the first embodiment, application software, a content file, and a content database need to be installed in the HDD 103. It suffices to execute this installation once.

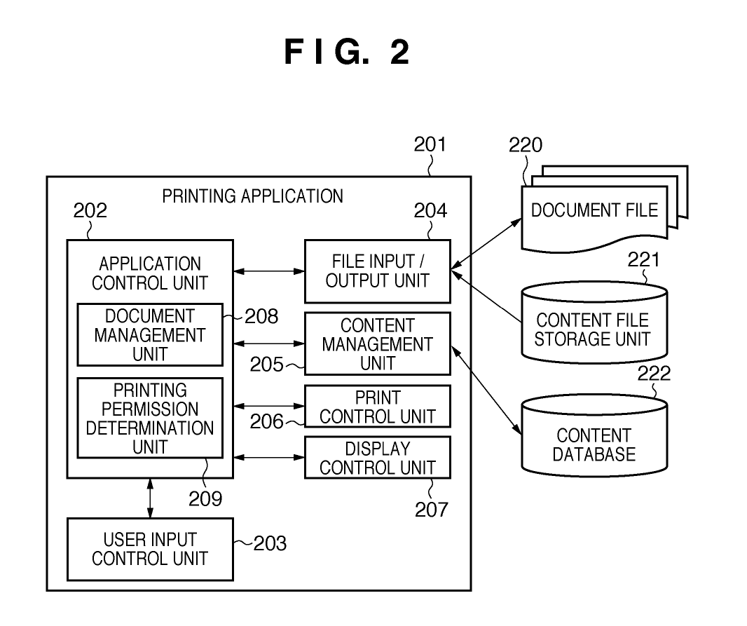

FIG. 2 is a block diagram showing the software configuration of a printing application which makes the PC 100 function as the information processing apparatus in the first embodiment. A printing application 201 includes an application control unit 202, user input control unit 203, file input/output unit 204, content management unit 205, printing control unit 206, and display control unit 207. The application control unit 202 includes a document management unit 208 and printing permission determination unit 209.

The user input control unit 203 acquires an input from the user via the keyboard 110 or pointing device 111. The file input/output unit 204 saves, as a document file 220 in the HDD 103, a document which has been created by the user using the printing application 201 and is used for printing. Also, the file input/output unit 204 loads the document file 220 saved in the HDD 103. In the embodiment, the document need not always contain a text, and includes one formed from, for example, only images. Further, the file input/output unit 204 loads, from a content file storage unit 221 in the HDD 103, image data used when the user creates a document using the printing application 201. The content management unit 205 makes an inquiry to a content database 222 built in the HDD 103, and updates data. The display control unit 207 controls the liquid crystal display 109 to display the operation screen of the printing application 201. The printing control unit 206 controls the printer 112 to print image data designated by the user via the printing application 201. The application control unit 202 comprehensively controls the operations of these units.

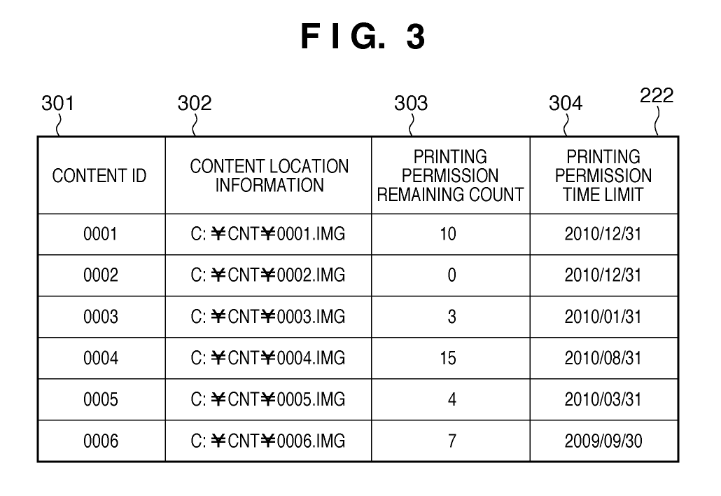

FIG. 3 is a table showing an example of the content database 222. The content database 222 holds data of the table format in which a content ID 301, content location information 302, printing permission remaining count 303, and printing permission time limit 304 correspond to each other for each content (image data). The content ID 301 is indicated by a four-digit numerical value. The content location information 302 is represented by a character string which is a combination of the position and file name of a content file in the folder hierarchy in the HDD 103. In the example of FIG. 3, a content file having a content ID “0001” is a file “0001.IMG” in a subfolder “CNT¥” contained in a folder “C:¥” in the HDD 103.

The printing permission remaining count 303 and printing permission time limit 304 are printing permission information of image data serving as a content. As for image data having a content ID “0001” in FIG. 3, printing permission information indicates that printing is permitted by 10 more times, but the 11th printing is inhibited (11th printing is not to be permitted, or, 11th printing is disabled). The printing permission information also indicates that the printing permission time limit of the image data is 2010/12/31, and even if the printing count has not reached 10, printing is inhibited after 2010/12/31.

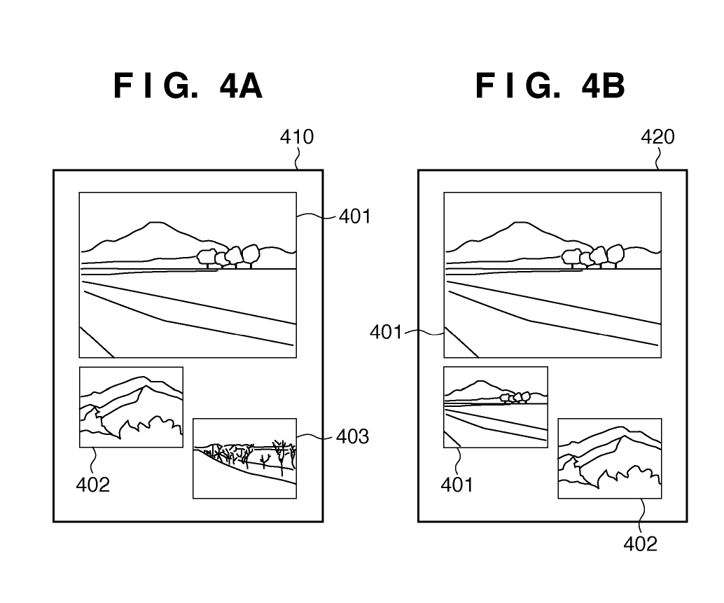

FIGS. 4A and 4B are views each showing an example of a document created by the user using the printing application 201. A document file 410 shown in FIG. 4A is acquired by laying out and editing three image data on one printing medium (one page) on a preview screen serving as an example of the layout display. Image data 401, 402, and 403 in the document file 410 use images having content IDs “0001”, “0002”, and “0003” in the content database 222 of FIG. 3. A document file 420 shown in FIG. 4B is also a document obtained by laying out three image data on one page. The document file 420 uses twice the image data 401 having the content ID “0001” in the content database 222 of FIG. 3, and once the image data 402 having the content ID “0002”. Of these image data, the image data 402 having the content ID “0002” already has a printing permission remaining count of 0, as shown in FIG. 3. If the current date is 2009/12/1, both the document files 410 and 420 contain image data still capable of print processing, but printing of the entire documents is inhibited. That is, in the first embodiment, this document is not printed as long as printing is permitted for all contents contained in the document to be printed. This prevents printing in an imperfect state (printing only a printing-permitted content though a plurality of contents are laid out).

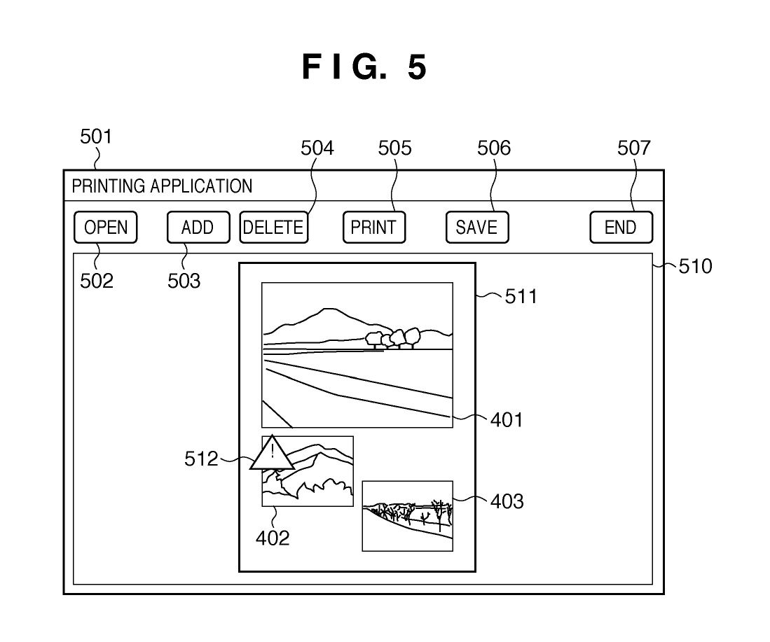

FIG. 5 is a view showing an example of a screen displayed on the liquid crystal display 109 of the PC 100 by the printing application 201 when creating the document file 410 using the printing application 201. The printing application 201 displays, on a screen 501, an open button 502, add button 503, delete button 504, print button 505, save button 506, end button 507, and document editing area 510.

When the user clicks the open button 502 with the pointing device 111, the printing application 201 displays a “open file” dialog screen (not shown). The user can select, in the dialog screen using the keyboard 110 and pointing device 111, the document file 220 saved in advance in the HDD 103. In response to this operation, the printing application 201 loads the selected document file 220, and displays its contents as a page image 511 in the document editing area 510.

When the user clicks the add button 503, the printing application 201 displays a “select image” dialog screen (not shown). The user can select, as a content in the dialog screen, image data registered in the content database 222 of the HDD 103. In response to this operation, the printing application 201 reads out image data corresponding to the selected content from the content file storage unit 221, and lays it out in the page image 511. If the user clicks the delete button 504 after selecting an image in the page image 511, the printing application 201 deletes the selected image data from the page image 511.

When the user clicks the print button 505, the printing application 201 performs print processing for a document displayed in the page image 511. At this time, the document management unit 208 specifies all image data in the document, and the content management unit 205 acquires printing permission information of the specified image data from the content database 222. Based on the acquired printing permission information, the printing permission determination unit 209 determines whether the document contains printing-inhibited (printing-disabled) image data. Only when the document does not contain printing-disabled image data, the printing control unit 206 performs print processing for the document, and the printer 112 prints the document. When the document is printed, the content management unit 205 updates printing permission information in the content database 222 for each specified image data. For example, the printing permission remaining count 303 is decremented by the number of contents used in the document.

When the user clicks the save button 506, the printing application 201 displays a “save in file” dialog screen (not shown). The user can designate a save location and file name in the folder hierarchy of the HDD 103. In response to this operation, the printing application 201 records content information of the document displayed in the page image 511 as the document file 220 having the designated file name at the designated save location. When the user clicks the end button 507, the printing application 201 closes the screen 501, ending the processing operation.

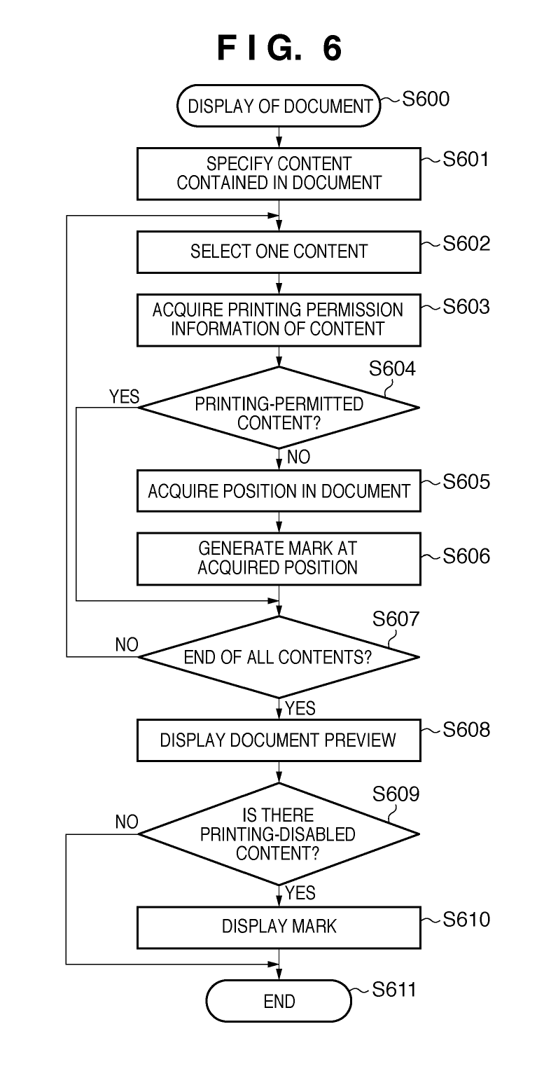

FIG. 6 is a flowchart showing a processing sequence of displaying document contents in the page image 511 by the printing application 201. When the document file 220 is loaded in response to pressing the open button 502, or when image data is added by pressing the add button 503, the printing application 201 executes the processing shown in FIG. 6. For example, the CPU 102 executes the processing shown in FIG. 6.

When the display processing shown in FIG. 6 starts (step S600), the document management unit 208 specifies all image data (contents) contained in a document during creation (step S601). Then, the document management unit 208 selects one image data from all the specified image data (step S602). The content management unit 205 makes an inquiry to the content database 222, and acquires printing permission information about the selected image data (step S603). Based on the acquired printing permission information, the use count of the selected image data in the document, and the current date information, the printing permission determination unit 209 determines whether printing of the selected image data is permitted (step S604). If the printing permission determination unit 209 determines that printing is permitted, the process advances to step S607; if it determines that printing is inhibited, to step S605.

In this case, when the printing permission remaining count in the acquired printing permission information becomes smaller than the use count of the image data in the document, it is determined that printing is inhibited. Also when the printing permission time limit in the acquired printing permission information is a date earlier than the current date, it is determined that printing is inhibited. In other cases, it is determined that printing is permitted. For example, the content database of FIG. 3 indicates that the image data 401 and 402 in the document file 410 shown in FIG. 4A have printing permission remaining counts of 10 and 0, respectively, and a printing permission time limit of 2010/12/31. Each of the image data 401 and 402 is used once in the document file 410. Assuming that the current date is 2009/12/1, it is determined for the image data 401 that printing is permitted because the printing permission remaining count of 10 is larger than the use count of 1 in the document file 410 and the printing permission time limit is later than the current date. As for the image data 402, it is determined that printing is inhibited because the printing permission time limit is later than the current date, but the printing permission remaining count is already 0 and is smaller than the use count of 1 in the document file 410.

If the printing permission determination unit 209 determines in step S604 that printing is inhibited, the document management unit 208 acquires the position of the selected image data in the document. When the same image data is used at a plurality of portions in the document, all the positions are acquired (step S605). Further, the document management unit 208 generates mark information (warning mark) to be displayed identifiably at the acquired position on a layout in the layout display (step S606).

In step S607, the document management unit 208 determines whether the processes in steps S602 to S606 have been done for all the image data in the document. If image data remains unprocessed, the process returns to step S602. In this case, in step S602, the document management unit 208 selects one of unprocessed image data. If all the image data have been processed, the process advances to step S608.

In step S608, the display control unit 207 acquires layout information and image data in the document from the document management unit 208 and file input/output unit 204, generates the preview image of the document, and displays it in the page image 511 on the editing screen 510. Then, the document management unit 208 determines whether the document contains one or more image data for which it has been determined in step S604 that printing is inhibited (step S609). If there is no image data for which it has been determined that printing is inhibited, the process ends (step S611). If there is one or more image data for which it has been determined that printing is inhibited, the display control unit 207 displays in step S610 a warning mark in the page image 511 based on the mark information generated by the document management unit 208 in step S606 to indicate that printing of the image data is inhibited. After that, a series of processes for displaying document contents in the page image 511 ends (step S611).

Note that when the same image data 401 is used by a plurality of number of times as in the document file 420 shown in FIG. 4B, the same contents are processed at once in step S602. For example, if the image data 401 is selected in the document file 420 in step S602, the printing permission remaining count of 10 for the selected image data 401 is compared with the use count of 2 in the entire document file 420 in the subsequent determination processing of step S604. Further, the printing permission time limit of 2010/12/31 is compared with the current date, and whether printing of the image data 401 is permitted is determined based on the determination results of the two comparisons. If the contents of the content database 222 are updated and the printing permission remaining count of the image data 401 becomes 1, the printing permission remaining count of 1 becomes smaller than the use count of 2 in the entire document in step S604, so it is determined that printing of the image data 401 is inhibited.

In the above processing, assuming that the current date is 2009/12/1, the printing application 201 displays the document contents in the page image 511 of FIG. 5 during creation of the document file 410. The image data 401, 402, and 403 are displayed at predetermined positions in the page image 511 in step S608. Of these image data, as for the image data 402 for which it is determined in step S604 that printing is inhibited, a warning mark 512 is added and displayed in step S610 as a mark indicating that printing is inhibited.

In the first embodiment, the user only sees the page image 511 to know printing-disabled image data (content) among a plurality of image data (contents) in a document (print data) before issuing an instruction to print the document. When printing of the document is inhibited upon pressing the print button 505, the user can easily specify the printing-disabled image data, delete it from the document by pressing the delete button 504, and change the document to a printing-permitted document. Since the warning mark 512 is displayed in the page image 511, the user can easily know, without clicking the print button 505, that printing of the document is inhibited, and image data which should be deleted to permit printing. Note that FIGS. 4A and 4B show only a document formed from one page. However, even for a document made up of a plurality of pages, the user can easily determine printing-disabled image data as long as the page image 511 on the editing screen 510 displays pages containing printing-disabled image data. The first embodiment has exemplified image data as printing-restricted contents, but various types of information (for example, text and figure) may be handled as contents.

In the above description, the content database 222 is built in the HDD 103, but may reside in another information processing apparatus capable of communicating with the PC 100 via a network (not shown). Also in the above description, the PC 100 and printer 112 are separated from each other. However, a single apparatus may have both the function explained with reference to FIGS. 2, 5, and 6, and a function of printing on a printing medium such as printing paper.

The page image 511 displays the warning mark 512 as a mark indicating that printing of image data is inhibited. Instead, a mark indicating the reason why printing of the image data is inhibited may be displayed. For example, it is determined that printing of the image data 401 is inhibited in the document file 420 shown in FIG. 4B, and a mark indicating shortage of the printing permission remaining count is displayed as a mark indicating the reason. The image data 401 is used twice in the document file 420. Hence, the user can easily know that printing of the document file 420 may be permitted by deleting the image data 401 from either position or replacing it with another image data. In contrast, when a mark indicating that the printing permission time limit has passed is displayed as a mark indicating the reason for the image data 401, the user can easily know that he has to delete or replace all the image data 401 used in the document file 420. The notification method is arbitrary as long as the user can be notified that printing of a specific content is inhibited. For example, a printing-disabled content may be displayed in a specific color.

In processing triggered by pressing the print button 505, an entire document during creation is printed by one copy. However, the printing application 201 allows setting one or more print copies of the document. In this case, when determining in step S604 whether printing of each image data is permitted, if the printing permission remaining count becomes smaller than a numerical value obtained by multiplying the use count of the image data in the document by the copy count, it is determined that printing is inhibited.

### Second Embodiment

In the first embodiment, a mark is displayed for printing-disabled image data out of a plurality of printing permission information-attached image data used in a document, allowing the user to easily know the printing-disabled image data. However, when a document is made up of many pages, the user may not be able to visually recognize the entire document at once. In this case, the user has to search the document for a mark indicating that printing is inhibited, in order to create a printing-permitted document. From this, the second embodiment will explain an example in which the position of printing-disabled image data is displayed quickly even for a document made up of many pages.

The hardware configuration of an information processing apparatus and the software configuration of a printing application in the second embodiment are the same as those in FIGS. 1 and 2 in the first embodiment, and a description thereof will not be repeated. However, the second embodiment has a feature in the processing operation of a printing application 201, which will be described with reference to the accompanying drawings. The structure of the content database is also the same as that in FIG. 3 in the first embodiment, and a description thereof will not be repeated. A difference from the first embodiment will be mainly explained.

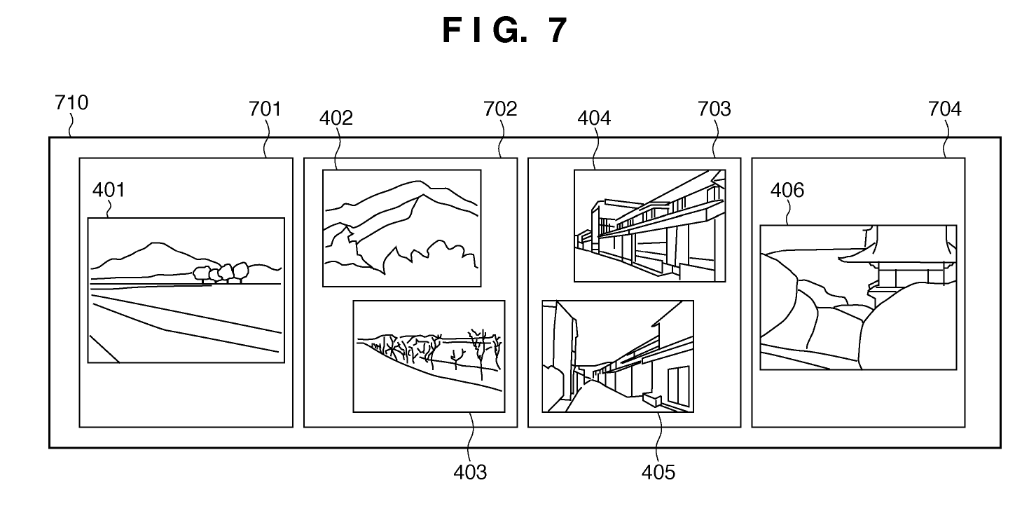

FIG. 7 is a view showing an example of a document which is created by the user using the printing application 201 and made up of a plurality of pages. A document file 710 is a document made up of a total of four pages, that is, a first page 701, second page 702, third page 703, and fourth page 704. Image data 401 is laid out on the first page, image data 402 and 403 are laid out on the second page, image data 404 and 405 are laid out on the third page, and image data 406 is laid out on the fourth page. In FIG. 7, the image data 401 to 406 use images having content IDs “0001” to “0006” in a content database 222 of FIG. 3. Of these image data, the image data 402 having the content ID “0002” already has a printing permission remaining count of 0.

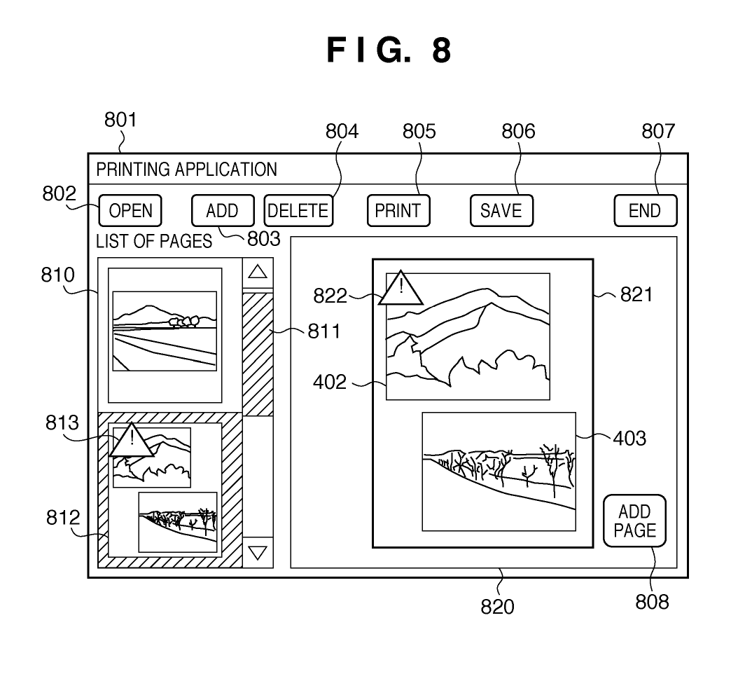

FIG. 8 is a view showing an example of a screen displayed on a liquid crystal display 109 of a PC 100 by the printing application 201 while creating the document file 710 using the printing application 201 in the second embodiment. In FIG. 8, reference numerals 801 to 807, 820, and 821 are the same as reference numerals 501 to 507, 510, and 511 in FIG. 5 in the first embodiment, and a description thereof will not be repeated. In the second embodiment, the printing application 201 displays a page add button 808 and page list 810 on the screen 801 in addition to the screen 501 in the first embodiment.

When the user clicks the page add button 808 with a pointing device 111, the printing application 201 adds a new blank page to a document during creation, and displays the contents of the blank page as the page image 821. The printing application 201 displays, in the page list 810, a list of the reduced images (thumbnail images) of respective pages in the document during creation. When the number of pages in the document is large and the page list 810 cannot display all the pages, a scroll bar 811 becomes valid, and the user can operate the scroll bar 811 to change the range of pages displayed in the page list 810. When the user selects an arbitrary page in the page list with the pointing device 111, the application 201 highlights the selected page, like a page 812 in FIG. 8, and displays the contents of the page in the page image 821.

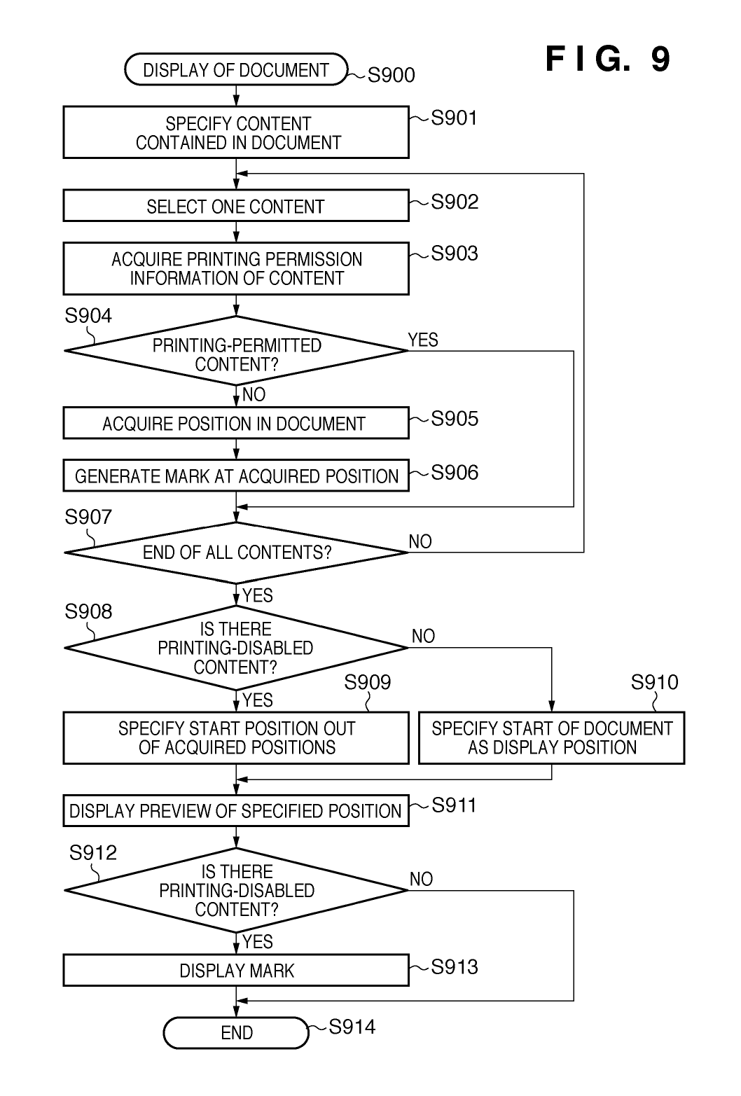

FIG. 9 is a flowchart showing a processing sequence of displaying document contents in the page image 821 by the printing application 201 in the second embodiment. For example, a CPU 102 executes the processing shown in FIG. 9. When a document file 220 is loaded in response to pressing the open button 802, the application 201 starts the processing shown in FIG. 9 (step S900). Processes in steps S901 to S907 of FIG. 9 are the same as those in steps S601 to S607 of FIG. 6, and a description thereof will not be repeated.

In step S908, a document management unit 208 determines whether the document contains one or more image data for which it has been determined in step S904 that printing is inhibited. If it is determined that there is one or more image data for which it has been determined that printing is inhibited, the process advances to step S909; if NO, to step S910.

In step S909, the document management unit 208 specifies, as the position of printing-disabled image data, a position closest to the start of the document out of positions acquired in step S905. In step S910, the document management unit 208 specifies the start position of the document.

Then, a display control unit 207 changes a page containing the position specified in step S909 or S910 to a selected state in the page list 810, and displays the page contents in the page image 821 (step S911). The document management unit 208 determines whether the document contains one or more image data for which it has been determined in step S904 that printing is inhibited (step S912). If there is no image data for which it has been determined that printing is inhibited, the process ends (step S914). If it is determined that there is one or more image data for which it has been determined that printing is inhibited, the display control unit 207 displays a mark in the page list 810 and page image 821 based on the mark information generated in step S806 to indicate that printing of the image data is inhibited (step S913). Thereafter, a series of processes for displaying document contents in the page image 821 ends (step S914).

Assuming that the current date is 2009/12/1, the document file 710 shown in FIG. 7 is displayed like the page list 810 and page image 821 shown in FIG. 8. At this time, a printing permission determination unit 209 determines in step S904 that printing of the image data 402 having the content ID “0002” in the content database shown in FIG. 3 is inhibited because its printing permission remaining count is 0. Also, the printing permission determination unit 209 determines that printing of the image data 406 having the content ID “0006” is inhibited because the current date has passed the printing permission time limit. Since there are image data for which it is determined that printing is inhibited, the process advances from step S908 to step S909, and the document management unit 208 specifies the position of the image data 402 in the second page 702 shown in FIG. 7 that is closest to the start of the document out of the image data 402 and 406. Based on this position, the display control unit 207 displays the second page 702 on the screen 801 in step S911. On the screen 801, the page containing the image data 402 is displayed in the page list 810 and page image 821. The user can easily know the positions of printing-disabled image data from warning marks 813 and 822.

In the above description, the printing application 201 executes the processing of FIG. 9 when the document file 220 is loaded. However, even at another timing, the same processing may be performed when the user executes a specific operation on the screen 801 of the printing application 201. Of printing-disabled image data, the position of one closest to the start of the document file 220 is displayed. Alternatively, the position of the closest printing-disabled image data in the page 812 selected in the page list 810 during creation of the document may be displayed.

Even if a plurality of image data each having printing permission information are distributed on a plurality of pages in a document, the user can easily know printing-disabled image data out of a plurality of image data by only seeing the screen 801 before issuing a printing instruction. The processing of the printing application 201 shown in FIG. 9 can provide the user in an easy-to-understand manner with printing permission information about a document file made up of a plurality of pages containing a plurality of image data.

Even in the second embodiment, the content database 222 may reside in another information processing apparatus capable of communicating with the PC 100 via a network (not shown). The content may be one other than image data. A single apparatus may have both the function explained with reference to FIGS. 2, 8, and 9, and a function of printing on a printing medium such as printing paper. A mark indicating the reason why printing of image data is inhibited may be displayed on the page image 821. As the method of notifying that printing of a specific content is inhibited, various methods can be employed. The print copy count of a document can also be set to one or more upon pressing the print button 805. In this case, when determining in step S904 whether printing of each image data is permitted, if the printing permission remaining count becomes smaller than a numerical value obtained by multiplying the use count of the image data in the document by the copy count, it is determined that printing is inhibited.

### Third Embodiment

The first and second embodiments have explained an information processing apparatus which helps the user to create a document by presenting the position of printing-disabled image data to the user in an easy-to-understand manner in the printing application 201. However, unless the user executes the printing application 201 and opens a document file, he cannot know whether printing of the document file is permitted, and even if printing is permitted, how many times printing is permitted. To solve this, the third embodiment will explain an example in which a PC 100 displays printing permission information about a saved document file before the user executes a printing application 201.

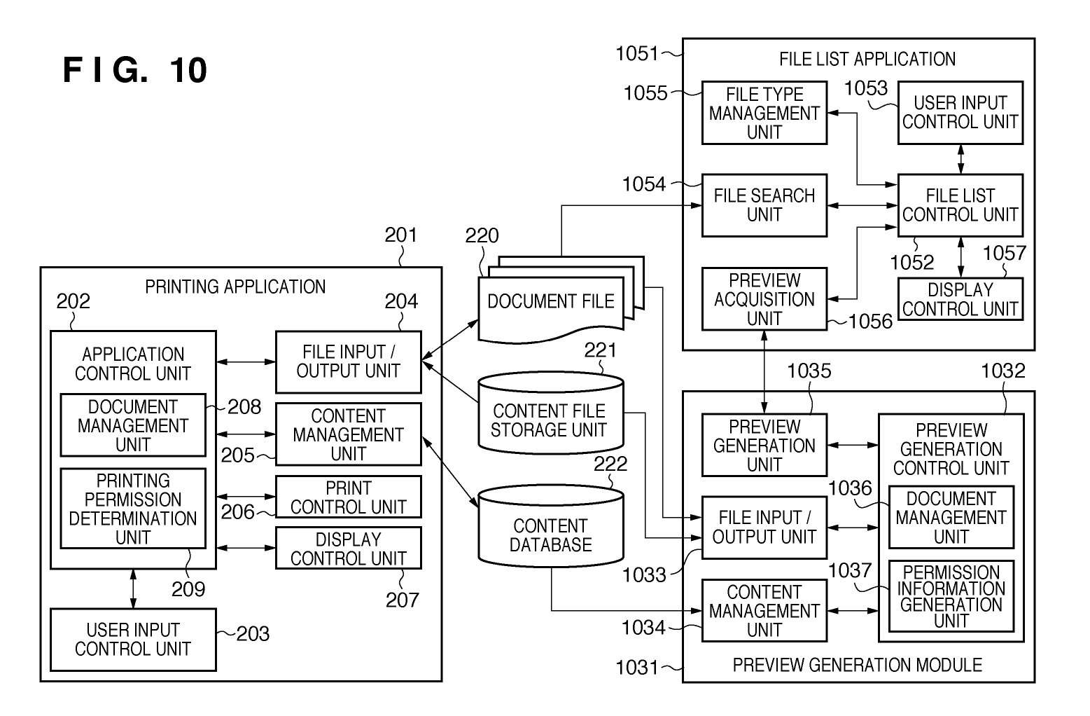

The hardware configuration of an information processing apparatus in the third embodiment is the same as that in FIG. 1 in the first embodiment, and a description thereof will not be repeated. FIG. 10 is a block diagram showing the software configurations of a preview generation module 1031, a file list application 1051 which activates the module, and the printing application 201 pertaining to them. Of these components, the printing application 201 and its arrangement are the same as those shown in FIG. 2 in the first or second embodiment, and a description thereof will not be repeated. Also, a document file 220, content file storage unit 221, and content database 222 are the same as those in the first or second embodiment.

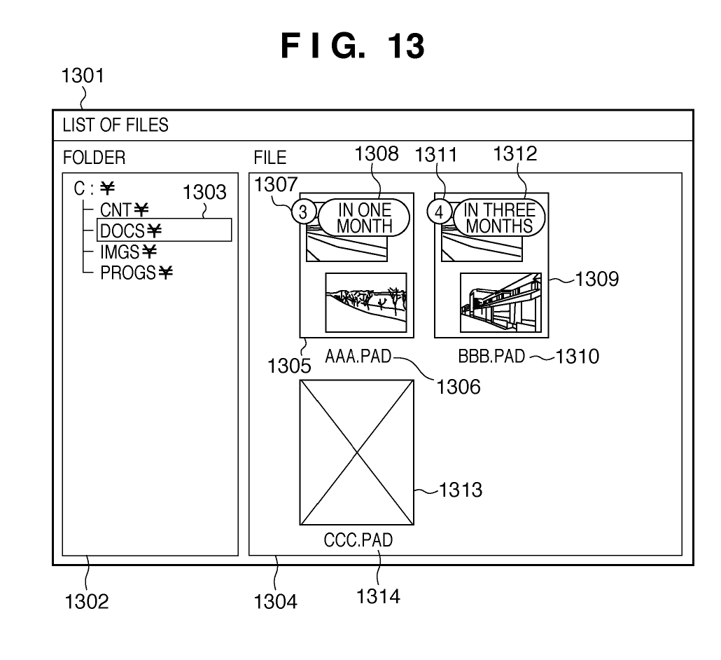

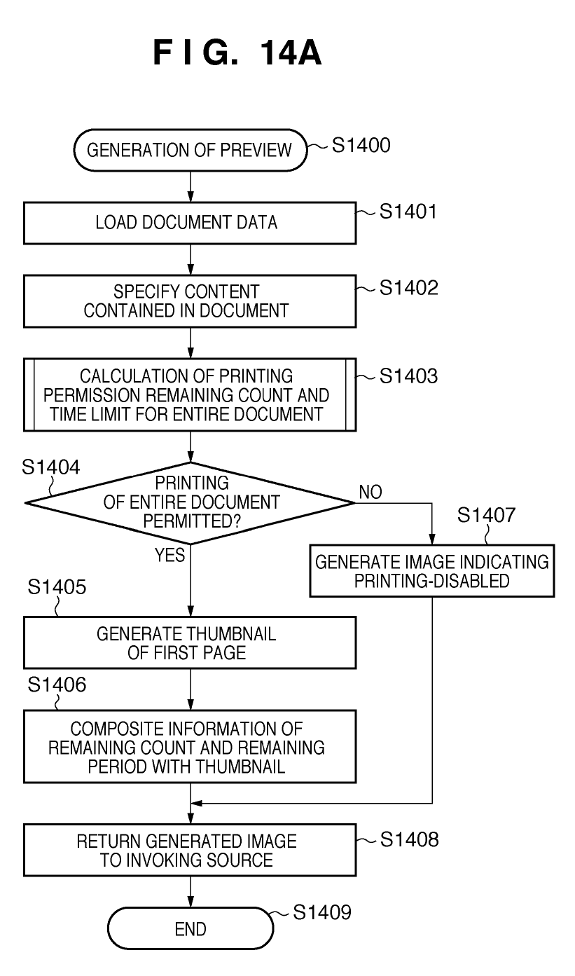

The file list application 1051 displays a list of files stored in a specific folder in an HDD 103 on a screen 1301 of a type shown in FIG. 13 (to be described later). The file list application 1051 includes a file list control unit 1052, user input control unit 1053, file search unit 1054, file type management unit 1055, preview acquisition unit 1056, and display control unit 1057. The file list application 1051 is stored in the HDD 103, and when it is activated in accordance with a user operation, read out to a RAM 104 and executed by a CPU 102. A work area in execution is ensured in the RAM 104.

The user input control unit 1053 acquires an input from the user via a keyboard 110 or pointing device 111. The file list control unit 1052 controls respective units (to be described later) in accordance with an input from the user, and performs processing requested by him for a file (for example, activating a predetermined application to open a file). The file search unit 1054 searches the HDD 103 for a file contained in a folder designated as the display target of the file list application 1051.

For each type of file stored in the HDD 103, the file type management unit 1055 manages a corresponding processing operation and corresponding preview generation module. In the third embodiment, a part after a period closest to the end of the name of a file stored in the HDD 103 represents the type of the file. When installing an arbitrary application in the HDD 103, the application and a corresponding preview generation module are registered for the type of a file associated with the application (for example, a document file to be saved by the application).

Assume that a document file (print data) saved by the printing application 201 in the third embodiment has “PAD” at the end following a period, like “AAA.PAD”. The file type management unit 1055 registers the character string “PAD” indicating the file type and the printing application 201 in association with each other. When the user selects a file “AAA.PAD” displayed on the screen of the file list application 1051, the file type management unit 1055 specifies the printing application 201 as software associated with this file type. Then, the file list control unit 1052 activates the printing application 201, and instructs it to open “AAA.PAD” as an activation option. Upon activation, the printing application 201 opens the document file “AAA.PAD” in accordance with the instruction, and displays the document in a creatable state on the screen. The file type management unit 1055 registers the character string “PAD” indicating the file type, and the preview generation module 1031 in association with each other.

The preview acquisition unit 1056 acquires the preview image of each file to be displayed on the screen of the file list application 1051. If the specified folder contains the file “AAA.PAD”, the file type management unit 1055 specifies the preview generation module 1031 associated with this file type. The preview acquisition unit 1056 activates the preview generation module 1031, transfers location & file name information of the file “AAA.PAD” to the preview generation module 1031, and causes the preview generation module 1031 to generate a preview image. The display control unit 1057 displays the screen shown in FIG. 13 such that, for example, a generated/acquired preview image is displayed.

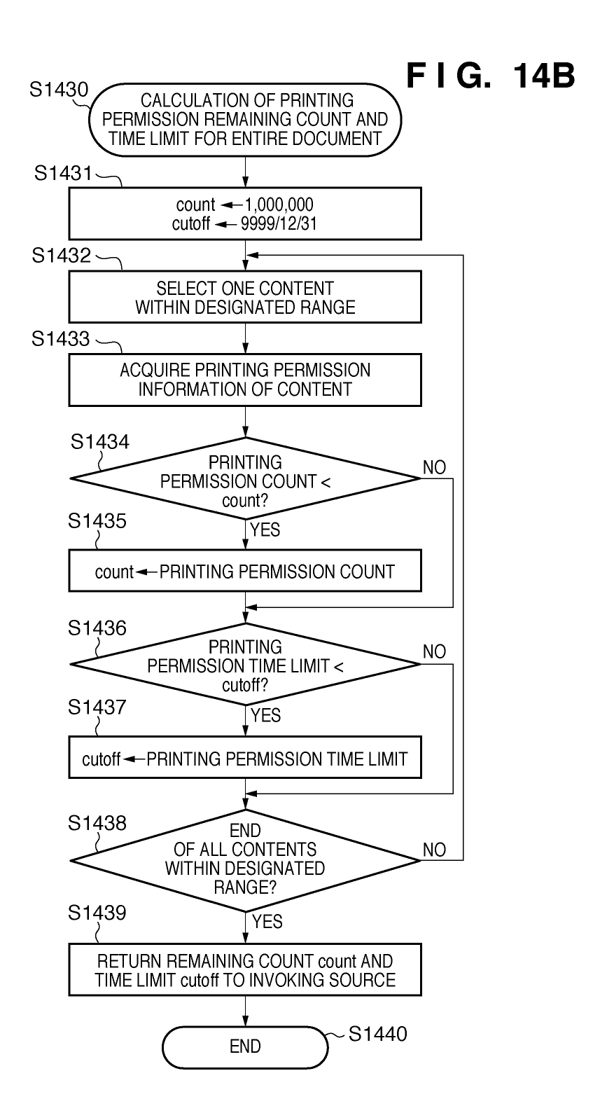

Simultaneously when installing the printing application 201 in the HDD 103, the preview generation module 1031 is installed in the HDD 103, and registered in the file type management unit 1055. For a document file created by the printing application 201, the preview generation module 1031 generates a preview image to be displayed by the file list application 1051, and transfers it to the file list application 1051. The preview generation module 1031 includes a preview generation control unit 1032, file input/output unit 1033, content management unit 1034, and preview generation unit 1035. Of these units, the preview generation control unit 1032 includes a document management unit 1036 and permission information generation unit 1037. The functions and operations of these units will be described later with reference to FIGS. 14A and 14B.

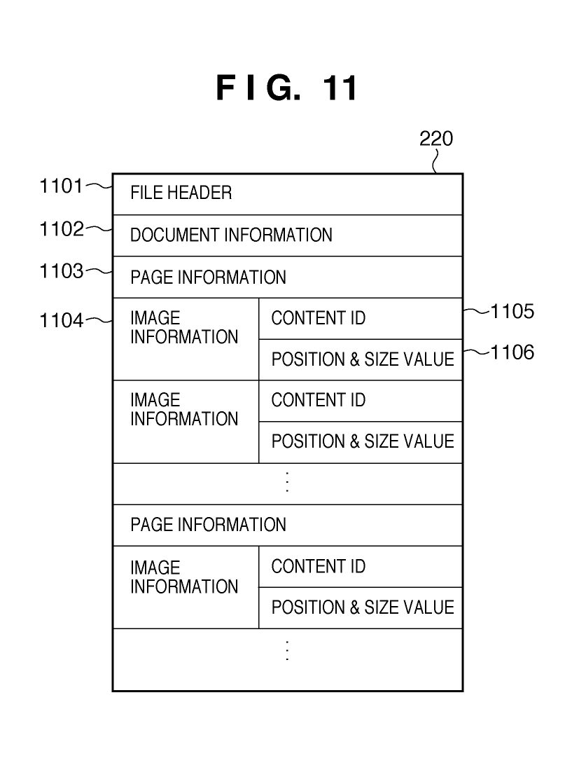

FIG. 11 is a view showing an example of the internal structure of the document file 220 saved in the HDD 103 by the printing application 201 in the third embodiment. The start of the file 220 is a file header 1101 which records information indicating that this file is a document file created by the printing application 201. Then, document information 1102 follows as information about the entire document such as the total number of pages of the document. The next is page information 1103 about the first page of the document. The page information 1103 records the number of image data in the page and the like. Pieces of image information 1104 each about individual image data follow by the number of image data in the page. Each image information 1104 contains a content ID 1105 of image data, and a position & size value 1106 serving as layout information of the image data on the paper surface. However, the document file 220 does not contain image data itself. The page information 1103 and following image information 1104 are repeated by the number of pages of the entire document. Note that the document file 220 may contain information such as the document creator name in addition to the above-mentioned information.

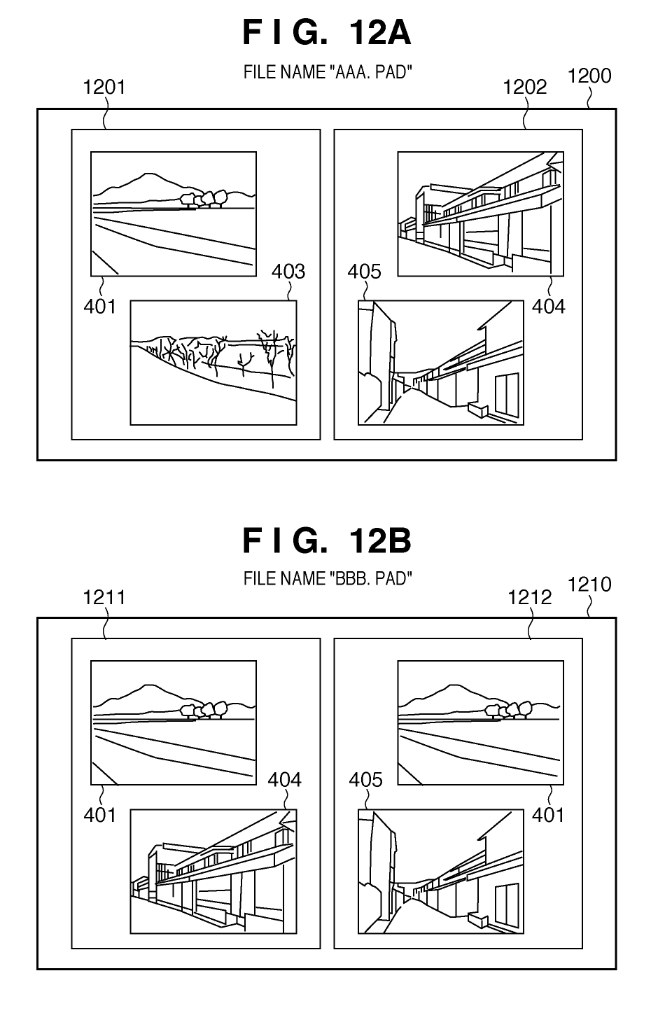

FIGS. 12A and 12B are views each showing an example of a document which is created by the user using the printing application 201 and made up of a plurality of pages. A document file 1200 shown in FIG. 12A is a document made up of two pages, that is, a first page 1201 and second page 1202. Image data 401 and 403 are laid out on the first page 1201 of the document file 1200, and image data 404 and 405 are laid out on the second page 1202. The file name is “AAA.PAD”. Similarly, a document file 1210 shown in FIG. 12B is made up of two pages, that is, a first page 1211 and second page 1212. The image data 401 and 404 are laid out on the first page 1211, and the image data 401 and 405 are laid out on the second page 1212. That is, the image data 401 is used twice in the document file 1210. The document file 1210 has a file name “BBB.PAD”. The image data 401, 403, 404, and 405 in FIGS. 12A and 12B are images having the content IDs “0001”, “0003”, “0004”, and “0005” in the content database 222 shown in FIG. 3, respectively. A printing permission remaining count 303 of each of these images is one or more in the state of FIG. 3. Assuming that the current date is 2009/12/1, all the images have not reached their printing permission time limits.

FIG. 13 is a view showing an example of a screen displayed on a liquid crystal display 109 of the PC 100 by the display control unit 1057 when executing the file list application 1051 in the third embodiment. The file list screen 1301 shown in FIG. 13 includes a folder display portion 1302 and file display portion 1304. Of these portions, the folder display portion 1302 visually displays a folder hierarchy in the HDD 103, and highlights a folder selected in the folder hierarchy, like a folder 1303. The file display portion 1304 displays a list of pairs each of the preview and file name of a file contained in the folder 1303 selected in the folder display portion 1302. Assume that a folder “C:¥DOCS¥” selected now in the folder display portion 1302 stores the “AAA.PAD” file 1200 shown in FIG. 12A, the “BBB.PAD” file 1210 shown in FIG. 12B, and a document file 710 shown in FIG. 7. The document file 710 has a file name “CCC.PAD”.

As shown in FIG. 13, file names 1306, 1310, and 1314 of files stored in the selected folder “C:¥DOCS¥” are displayed. Also, as shown in FIG. 13, preview images 1305, 1309, and 1313 of the respective files having the file names 1306, 1310, and 1314 are displayed. Pieces of printing permission information 1307 and 1308, and pieces of printing permission information 1311 and 1312 are embedded in the preview images 1305 and 1309, respectively, out of these preview images. Processing of generating these preview images will be explained with reference to FIGS. 14A and 14B.

FIGS. 14A and 14B are flowcharts showing the processing sequence of the preview generation module 1031 in the third embodiment. For example, the CPU 102 executes the processes shown in FIGS. 14A and 14B. FIG. 14A shows the overall preview generation processing. FIG. 14B shows a processing sequence of calculating a printing permission remaining count and printing permission time limit for a specific range in a document that are used in the preview generation processing.

When the folder “C:¥DOCS¥” is selected in the folder display portion 1302 of FIG. 13, the file search unit 1054 searches for files in the folder. If the “AAA.PAD” file 1200 is detected in the folder, a part after a period at the end of the file name is “PAD”, so the file type management unit 1055 specifies a preview generation module 1031 corresponding to the file. Then, the preview acquisition unit 1056 activates the preview generation module 1031, and transfers the file-storing folder name “C:¥DOCS¥” and file name “AAA.PAD” as information of a document file to be processed (step S1400).

After activating the preview generation module 1031, the file input/output unit 1033 loads the document file 220 based on the transferred folder name and file name (step S1401). The document file 220 at this time is the “AAA.PAD” file 1200. The document management unit 1036 specifies image data used in the document by referring to the content ID 1105 contained in the image information 1104 in the loaded document file 220 (step S1402). By the processes of the content management unit 1034, document management unit 1036, and permission information generation unit 1037, the printing permission remaining count and printing permission time limit of the entire document are calculated (step S1403). Details of the calculation processing will be described with reference to FIG. 14B.

Based on the printing permission remaining count and printing permission time limit calculated in step S1403, the permission information generation unit 1037 determines whether printing of the entire document file 220 is permitted at present (example of the second determination). More specifically, if the printing permission remaining count of the entire document file 220 is one or more, and the current date has not passed the printing permission time limit of the entire document file 220, the permission information generation unit 1037 determines that printing is permitted (step S1404). If the permission information generation unit 1037 determines that printing is permitted, the process advances to step S1405; if it determines that printing is inhibited, to step S1407.

In step S1405, the document management unit 1036 specifies image data contained in the first page of the document, and acquires the position & size value 1106 contained in the image information 1104 loaded from the document file 220. In addition, the file input/output unit 1033 acquires image data from the content file storage unit 221. Based on these pieces of information, the preview generation unit 1035 generates the reduced image (thumbnail) of the first page of the document. Then, the permission information generation unit 1037 calculates a printing permission remaining period based on the current date and the printing permission time limit calculated in step S1403. The preview generation unit 1035 composites the printing permission remaining period as text information with the thumbnail together with the calculated printing permission remaining count (step S1406). If the process advances to step S1407, the preview generation unit 1035 generates an x-mark image as an image indicating inhibition of printing.

In either case, the preview generation unit 1035 transfers the generated image to the preview acquisition unit 1056 of the file list application 1051 (step S1408), ending the preview generation processing (step S1409). Thereafter, the same processing is also executed for the remaining files “BBB.PAD” and “CCC.PAD” present in the same folder.

The processing sequence of calculating a printing permission remaining count and printing permission time limit for a specific range in a document will be explained with reference to FIG. 14B. If the entire document is designated in step S1403 of FIG. 14A to invoke the processing of FIG. 14B (step S1430), the permission information generation unit 1037 generates a numerical variable count and date variable cutoff in the work area within the RAM 104. The permission information generation unit 1037 sets 1,000,000 as the count value and 9999/12/31 as the cutoff value (step S1431). Assume that the printing permission remaining counts of all image contents used in the document are values smaller than the initial value “1,000,000” of the variable count. Also, assume that the printing permission time limits of all image data used in the document are earlier than the initial value of the variable cutoff.

Then, the document management unit 1036 selects one type of image data contained in the document range designated by the invoking source of the processing in FIG. 14B. If the processing in FIG. 14B is invoked from step S1403 of FIG. 14A, any one type of image data is selected from the entire document file (step S1432). The content management unit 1034 makes an inquiry to the content database 222, and acquires printing permission information of the image data selected in step S1432 (step S1433).

Then, the permission information generation unit 1037 compares the value of the variable count with a value obtained by dividing the printing permission remaining count in the printing permission information acquired in step S1433 by a count at which the same image is contained in the document range designated by the invoking source (step S1434). If the value of the variable count is larger, the process advances to step S1435; if it is equal or smaller, to step S1436. In step S1435, the permission information generation unit 1037 updates the value of the variable count to the value obtained by dividing the printing permission remaining count acquired in step S1433 by a count at which the same image is contained in the document range designated by the invoking source. Similarly, the permission information generation unit 1037 compares the value of the variable cutoff with the printing permission time limit in the printing permission information acquired in step S1433 (step S1436). If the value of the variable cutoff indicates a later date, the process advances to step S1437; if NO, to step S1438. In step S1437, the permission information generation unit 1037 updates the value of the variable cutoff to the value of the printing permission time limit acquired in step S1433.

In step S1438, the document management unit 1036 determines whether the processes in steps S1432 to S1437 have ended for all image data contained in the document range designated by the invoking source of the processing in FIG. 14B. If unprocessed image data remains, the process returns to step S1432 to select the next image data and repeat the processes.

If the processes in steps S1432 to S1437 have ended for all image data, the permission information generation unit 1037 sets the value of the variable count as a printing permission remaining count and the date indicated by the value of the variable cutoff as a printing permission time limit, and returns the calculation results to the invoking source (step S1439). After that, the processing of calculating a printing permission remaining count and printing permission time limit for a specific range in a document ends (step S1440).

Assume that the current date is 2009/12/1. By performing the above-described processing while the content database holds values shown in FIG. 3, the file list application 1051 displays the file display portion 1304 of the screen 1301 as shown in FIG. 13. As for the document file 1200 “AAA.PAD”, a printing permission remaining count of 3 and a printing permission time limit of 2010/1/31 are calculated by the processing of FIG. 14B. In the processing of FIG. 14A, the thumbnail of the first page 1201 is generated in step S1405, and “3” is composited as the printing permission remaining count 1307 in step S1406. Since the remaining period from the current date “2009/12/1” is shorter than two months, “in one month” is composited as a rough period at the printing permission remaining period 1308. The display control unit 1057 of the file list application 1051 displays these results.

The document file 1210 “BBB.PAD” uses the image data 401 twice. Hence, the printing permission count when the image data 401 is selected in step S1432 is “5” as a result of dividing, by the use count “2”, the value “10” recorded in the content database 222 for the content ID “0001”. However, the printing permission remaining count of the image data 405 is a smaller value “4”, so the printing permission count of the entire document is “4”. The printing permission time limit calculation result is 2010/3/31. The preview generation unit 1035 composites these pieces of information, and displays pieces of printing permission information 1311 and 1312, as shown in FIG. 13.

In contrast, as for the document file 710 “CCC.PAD, the printing permission remaining count of the image data 402 is 0, and the printing permission time limit of the image data 406 has already passed. It is therefore determined in step S1404 of FIG. 14A that printing is inhibited, and the preview generation unit 1035 transfers the x-mark generated in step S1407 to the file list application 1051. The file list application 1051 generates a display result represented by the preview display 1313 in FIG. 13.

By this arrangement, a plurality of preview displays can notify the user of printing permission information about a document file (print data) before issuing a printing instruction. By only seeing the screen 1301 of the file list application 1051, the user can easily know whether printing of a plurality of document files 220 is permitted. Also, the user can easily know the remaining printing count and period by which he can print the document file 220. To obtain these pieces of information, the user need neither activate the printing application 201 by an operation of, for example, selecting the document file 220 from the screen 1301, nor check the screen of the application. In this way, the user can know printing permission information of the created document file 220 by a simple operation. This can reduce the risk that, for example, the printing permission time limit of the document file 220 has passed before the user notices it, and printing of the document file 220 is inhibited. When a plurality of documents use the same image data, the user can know by a simple operation that after printing one document, the printing permission counts of the remaining documents also decrease. This can reduce the risk that the printing permission remaining count of a document runs out before the user notices it.

Note that the OS may implement some or all of the above-described functions. In the third embodiment, the file list application 1051 and preview generation module 1031 are separate units, but may be integrated.

In the third embodiment, printing permission information of a document is composited with the thumbnail of the first page of the document and displayed. However, an icon image indicating not document contents but only the type may be composited and displayed. Only printing permission information may be displayed together with a file name without compositing it with an image.

In the third embodiment, a combination of the printing permission remaining count and printing permission remaining period is displayed as printing permission information of a document, but either one may be displayed. It is also possible to display only either the printing permission remaining count or remaining period, and switch to and display the other every predetermined time or every time the user performs a predetermined operation to the file list application 1051. Instead of the printing permission remaining period, the printing permission time limit may be displayed. In the third embodiment, printing permission information such as the printing permission remaining count 1307 and printing permission time limit 1308 in FIG. 13 is composited as text information with the preview image 1305 and displayed. Alternatively, the remaining printing count and remaining period may be represented by figures such as marks, or numerals.

Even in the third embodiment, the content database 222 may reside in another information processing apparatus capable of communicating with the PC 100 via a computer network (not shown). A single apparatus may have both the function explained with reference to FIGS. 10, 13, and 14, and a function of printing on a printing medium such as printing paper. The content may be one other than image data.

### Fourth Embodiment

In the third embodiment, the preview generation module 1031 composites printing permission information about an entire document file with the preview images 1305 and 1309. As for a document file, printing of which is inhibited entirely, the x-mark 1313 is generated and displayed as display information. This allows the user to easily know printing permission information about each document file present in a target folder. However, the user can know only the fact that printing is inhibited for a printing-disabled document file. The fourth embodiment will explain an example in which when printing of some image data used in a document file is still permitted, printing permission information about a portion remaining in the printable state is displayed to the user.

The hardware configuration of an information processing apparatus in the fourth embodiment is the same as that in FIG. 1. Also, the software configurations of a preview generation module 1031, file list application 1051, and printing application 201 are the same as those in FIG. 10. However, the fourth embodiment has a feature in the processing operation of the preview generation module 1031, which will be described with reference to the accompanying drawings. The structure of the content database is also the same as those in the first to third embodiments. Assume that a folder “C:¥DOCS¥” in an HDD 103 saves, as document files, a document file 1200 shown in FIG. 12A, a document file 1210 shown in FIG. 12B, and a document file 710 shown in FIG. 7 which have been used in the description of the third embodiment. The file names of these document files are “AAA.PAD”, “BBB.PAD”, and “CCC.PAD”, respectively.

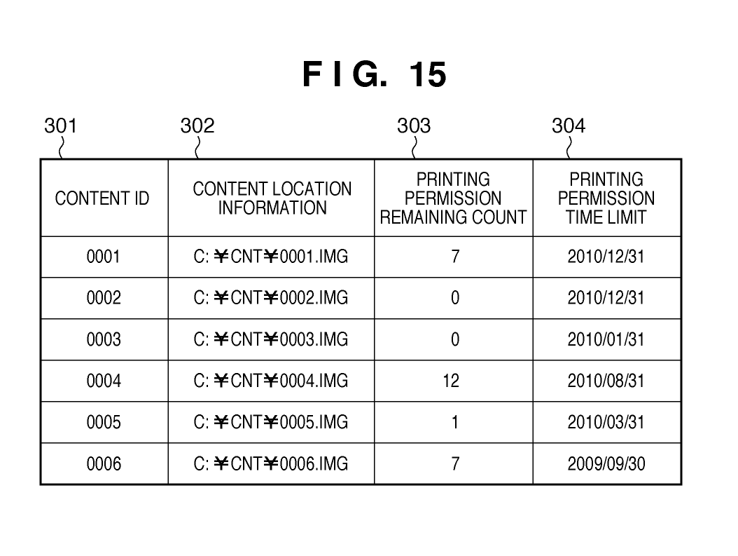

FIG. 15 is a table showing contents in a state in which the content database shown in FIG. 3 is updated. More specifically, FIG. 15 shows a state after the user prints the entire document file 1200 shown in FIG. 12A three times using the printing application 201 in the state shown in FIG. 3. The document file 1200 uses once each of image data 401, 403, 404, and 405, that is, image data having content IDs 301 “0001”, “0003”, “0004”, and “0005”. Every time the document file 1200 is printed once, printing permission remaining counts 303 of these image data are decremented by one. After the document file 1200 is printed three times, the printing permission remaining count for the content ID “0001” decreases by 3 from 10 in FIGS. 3 to 7 shown in FIG. 15. This also applies to the remaining image contents. In the state of FIG. 15, the printing permission remaining count 303 of image data having the content ID “0003” becomes 0, inhibiting printing of the image data.

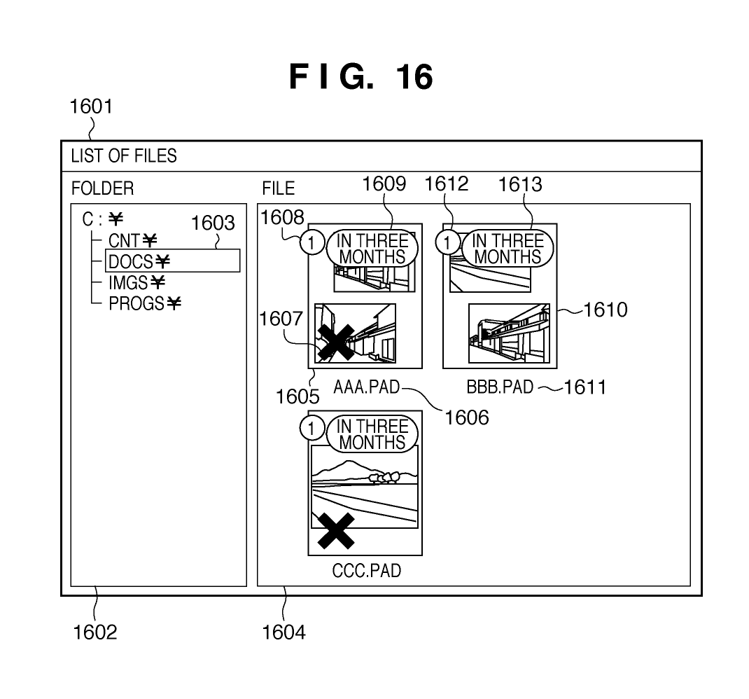

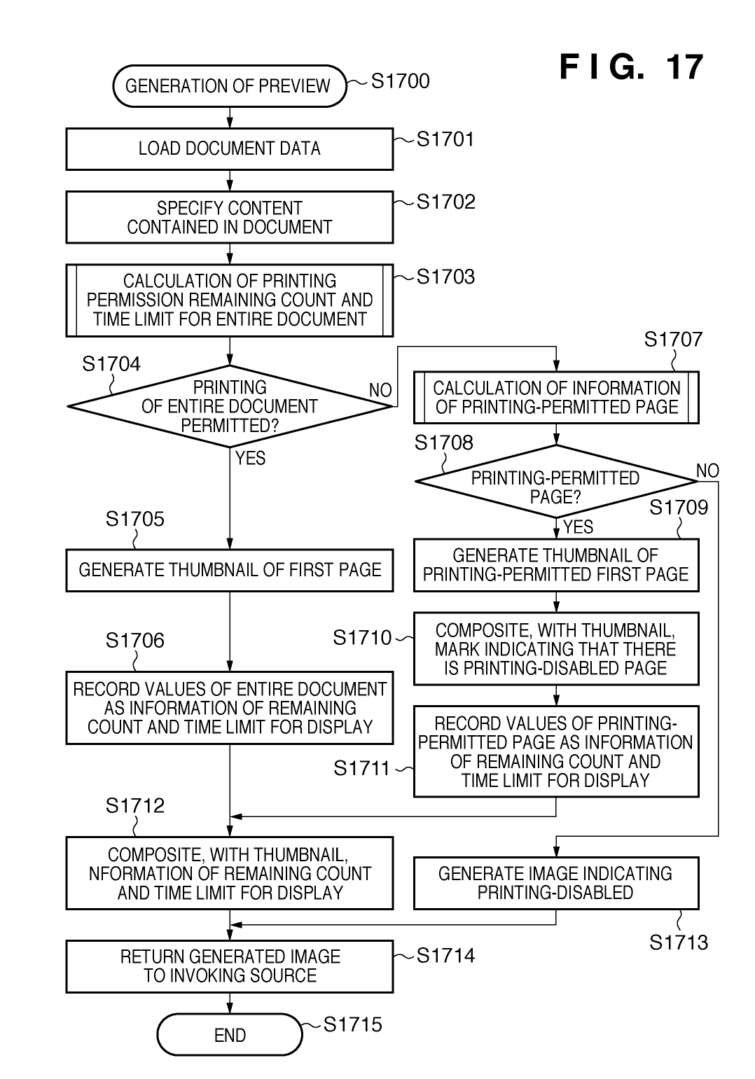

FIG. 16 is a view showing an example of a screen displayed on a liquid crystal display 109 of a PC 100 by a display control unit 1057 when executing the file list application 1051 in the fourth embodiment. Reference numerals 1601 to 1604, 1606, and 1610 to 1613 in FIG. 16 are the same as reference numerals 1301 to 1304, 1306, and 1309 to 1312 in FIG. 13 in the third embodiment. A preview image 1605 in FIG. 16 displays the preview image of a document file whose file name is displayed in the file name 1606. Pieces of printing permission information 1607 to 1609 are embedded in the preview image 1605. Assuming that the current date is 2009/12/1, preview image generation processing will be explained with reference to the accompanying drawings.

FIG. 17 is a flowchart showing the processing sequence of the preview generation module 1031 in the fourth embodiment. For example, a CPU 102 executes the processing shown in FIG. 17. When the user selects a folder “C:¥DOCS¥” in the folder display portion 1602 of FIG. 16, a file search unit 1054, file type management unit 1055, and preview acquisition unit 1056 operate similarly to the third embodiment. As a result, the preview acquisition unit 1056 activates the preview generation module 1031 (step S1700). At this time, the preview acquisition unit 1056 transfers a file-storing folder name “C:¥DOCS¥” and file name “AAA.PAD” as information of a document file to be processed to the preview generation module 1031. Processes in steps S1701 to S1703 are the same as those in steps S1401 to S1403 of FIG. 14A. Processing invoked in step S1703 to calculate a printing permission remaining count and printing permission time limit for an entire document is also the same as that shown in FIG. 14B.

In step S1704, based on the printing permission remaining count and printing permission time limit calculated in step S1703, a permission information generation unit 1037 determines whether printing of an entire document file 220 is permitted at present. A concrete determination method is the same as step S1404 of FIG. 14A. If the permission information generation unit 1037 determines that printing is permitted, the process advances to step S1705; if it is determined that printing is inhibited, to step S1707.

In step S1705, a document management unit 1036, file input/output unit 1033, and preview generation unit 1035 cooperate with each other to generate the thumbnail of the first page of the document file 220 by the same processing as step S1405 of FIG. 14A. As information of the remaining count and time limit to be displayed to the user, the permission information generation unit 1037 records, in a work area in a RAM 104, the printing permission remaining count and time limit of the entire document that have been acquired in step S1703 (step S1706).

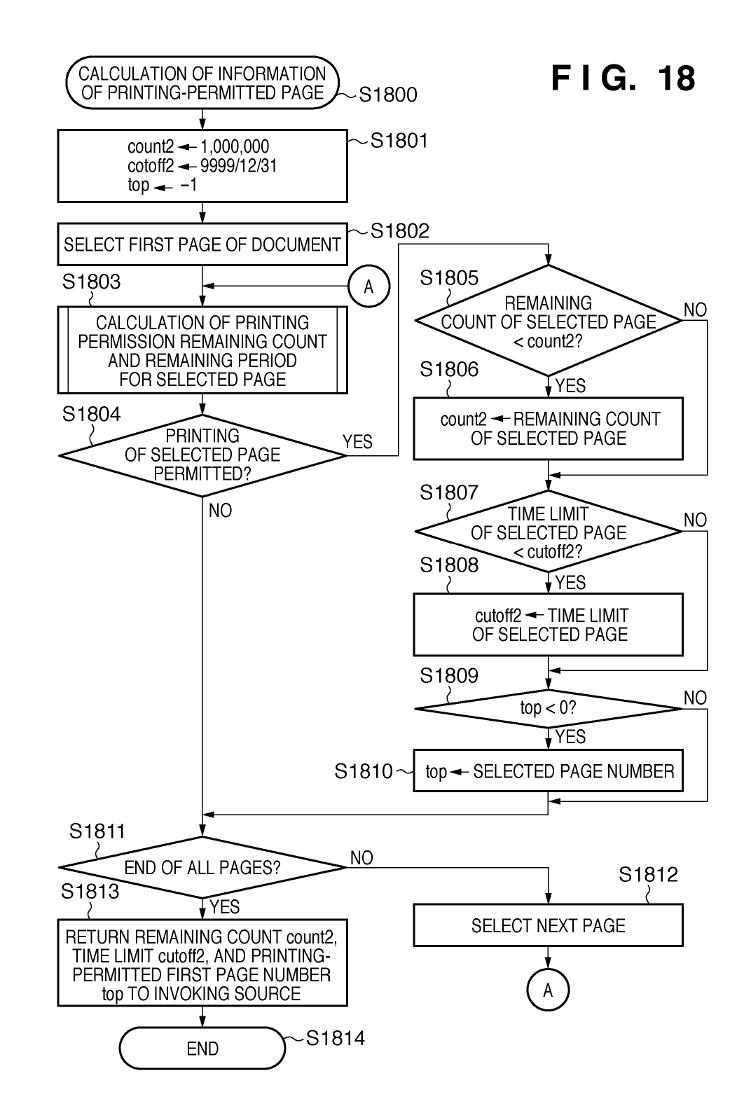

If the permission information generation unit 1037 determines in step S1704 that printing is inhibited, a content management unit 1034, the document management unit 1036, and the permission information generation unit 1037 calculate printing permission information about a printing-permitted page based on the current state of the content database 222 (step S1707). More specifically, assuming that the printing application 201 selects and prints only currently printing-permitted pages, the printing permission remaining count, the printing permission time limit, and the number of a page closest to the start of the document out of currently printing-permitted pages are calculated. Details of the calculation processing will be described with reference to FIG. 18.

Based on the result of the calculation processing in step S1707, the permission information generation unit 1037 determines whether there are one or more currently printing-permitted pages (step S1708). If a valid page number is acquired as the number of a page closest to the start of the document out of printing-permitted pages as the result of the processing in step S1707, the permission information generation unit 1037 determines that there is a printing-permitted page. If there is a printing-permitted page, the process advances to step S1709; if NO, to step S1713.

In step S1709, the document management unit 1036, file input/output unit 1033, and preview generation unit 1035 cooperate with each other to generate the thumbnail image of the page closest to the start of the document out of printing-permitted pages acquired in step S1707. The preview generation unit 1035 composites, with the thumbnail image, the second warning mark 1607 shown in FIG. 16 as a mark indicating that a printing-disabled page exists in the document file (step S1710). As information of the remaining count and time limit to be displayed to the user, the permission information generation unit 1037 records, in the work area in the RAM 104, the printing permission remaining count and time limit of the printing-permitted page that have been acquired in step S1707 (step S1711).

After the processing in step S1706 or S1711, the preview generation unit 1035 composites, with the thumbnail image, information about the printing permission remaining count and remaining period based on the information of the remaining count and time limit to be displayed to the user that has been recorded in the RAM 104 (step S1712).

If printing of all the pages of the document file is permitted, information of the printing permission remaining count and printing permission remaining period for the entire document file that has been recorded by the processing of step S1706 is composited with the thumbnail image of the first page of the document that has been generated in step S1705. As a result, a preview image similar to that in step S1406 in the third embodiment is generated. If printing of only some pages of the document file is permitted, information of the printing permission remaining count and printing permission remaining period for printing-permitted pages that has been recorded in step S1711 is composited with the thumbnail image composited in step S1710.

If the permission information generation unit 1037 determines in step S1708 that there is no printing-permitted page, the preview generation unit 1035 generates an x-mark image as an image indicating inhibition of printing, similar to step S1407 shown in FIG. 14A in the third embodiment (step S1713).

After that, the preview generation unit 1035 returns the image composited in step S1712 or generated in step S1713 to the file list application 1051 (step S1714), and the processing of the preview generation module 1031 ends (step S1715).

FIG. 18 is a flowchart showing a processing sequence of calculating printing permission information about a printing-permitted page by the preview generation module 1031 based on the current state of a content database 222. If this processing is invoked from step S1707 of FIG. 17 (step S1800), the permission information generation unit 1037 generates a numerical variable count2, date variable cutoff2, and numerical variable top in the work area in the RAM 104. The permission information generation unit 1037 sets 1,000,000 as the count2 value, 9999/12/31 as the cutoff2 value, and −1 as the top value (step S1801). Assume that the printing permission remaining counts of all image data used in a document file are values smaller than the initial value “1,000,000” of the variable count2. Also, assume that the printing permission time limits of all image data used in the document file are earlier than the initial value of the variable cutoff2.

Then, the document management unit 1036 selects the first page of the document file as a subsequent processing target (step S1802). For the selected page, the content management unit 1034, document management unit 1036, and permission information generation unit 1037 execute processing shown in FIG. 14B (step S1803). That is, a printing permission remaining count and printing permission time limit on the premise of printing only one selected page are calculated. Based on the printing permission remaining count and printing permission time limit calculated in step S1803, the permission information generation unit 1037 determines whether printing of the currently selected page is permitted (step S1804). More specifically, if the printing permission remaining count calculated in step S1803 is one or more, and the current date has not passed the printing permission time limit calculated in step S1803, the permission information generation unit 1037 determines that printing is permitted. If the permission information generation unit 1037 determines that printing is permitted, the process advances to step S1805; if it determines that printing is inhibited, to step S1811.

In step S1805, the permission information generation unit 1037 determines whether the value of the variable count2 is larger than the printing permission remaining count calculated in step S1803. If the value of the variable count2 is larger, the permission information generation unit 1037 updates the value of the variable count2 to the printing permission remaining count calculated in step S1803 (step S1806). If the value of the variable count2 is equal or smaller, the process advances to step S1807 without performing update processing. In step S1807, the permission information generation unit 1037 compares the printing permission time limit calculated in step S1803 with the value of the variable cutoff2. If the value of the variable cutoff2 indicates a later date, the permission information generation unit 1037 updates the value of the variable cutoff2 to the value of the printing permission time limit calculated in step S1803 (step S1808). If NO in step S1807, the process advances to step S1809 without performing update processing. In step S1809, the permission information generation unit 1037 determines whether the value of the variable top is smaller than 0. If the value of the variable top is smaller than 0, the permission information generation unit 1037 updates the value of the variable top to the number value of the currently selected page (step S1810). Assume that the page number value starts from 1.

After performing these processes, the document management unit 1036 determines in step S1811 whether the processes in steps S1803 to S1810 have ended for all the pages of the document file. If the processes have not ended for all the pages, the document management unit 1036 selects the next page as a processing target (step S1812), and the process returns to step S1803. If the processes have not ended for all the pages, the permission information generation unit 1037 returns the calculated printing permission information to the invoking source of the processing in FIG. 18, that is, to step S1707 of FIG. 17 (step S1813). The value of the variable count2 is returned as a printing permission remaining count for a printing-permitted page. The value of the variable cutoff2 is returned as a printing permission time limit for the printing-permitted page. The value of the variable top is returned as the number of a page closest to the start of the document out of printing-permitted pages. If no printing-permitted page exists in the document file, the value of the variable top remains -1 which has been set in step S1801, and can be determined as an invalid page number by the invoking source. As a consequence, the processing of calculating printing permission information about a printing-permitted page ends (step S1814).

For a document file, printing of which is permitted entirely, the preview generation module in the fourth embodiment generates an image obtained by compositing printing permission information with the thumbnail of the first page by the processes in steps S1705, S1706, and S1712, similar to the third embodiment. In a state in which the content database 222 holds values shown in FIG. 15, the preview image 1610 is generated by compositing the printing permission remaining count 1612 and printing permission remaining period 1613 with the document file 1210 “BBB.PAD”.

When printing of some of image contents used in a document is inhibited and printing of only some pages is permitted, a preview image is generated by compositing printing permission information about only a currently printing-permitted page by the processes in steps S1707 to S1712. As for the document file 1200 “AAA.PAD”, printing of the image data 403 having the content ID “0003” out of image data used is inhibited because its printing permission remaining count is 0, but printing of the remaining image data is still permitted. Thus, printing of a first page 1201 containing the image data 403 is inhibited, but printing of a second page 1202 is permitted. When printing only the second page 1202, its printing permission count is 1 because the image data 405 having the content ID “0005” exhibits a minimum printing permission count of 1. Also, the printing permission time limit of the second page 1202 is 2010/3/31 because the image data 405 having the content ID “0005” exhibits an earliest printing permission time limit of 2010/3/31. The preview generation module 1031 in the fourth embodiment generates a preview image for the document file 1200 by compositing the thumbnail of the printing-permitted second page 1202 and the warning mark 1607 indicating that printing of some pages of the document file 1200 is inhibited. The preview generation module 1031 composites even the pieces of printing permission information 1608 and 1609 of the second page with the preview image.

If there is no printing-permitted page as a result of inhibiting printing of some or all image contents used in the document, an image indicating that printing is inhibited is generated by the processing of step S1713. On the screen of FIG. 16, no such document file exists. However, for a document file having no printing-permitted page, the same preview display as the preview image 1313 shown in FIG. 13 in the third embodiment is generated.

As described above, printing permission information about a portion currently usable in a document file (print data) obtained by combining a plurality of image data (contents) can be presented to the user before a printing instruction. By only seeing the screen 1601 of the file list application 1051, the user can easily know whether printing of the document file 220 is permitted, and the count and period by which he can print the document file 220, similar to the third embodiment. In the information processing apparatus of the fourth embodiment, as for some printing-permitted pages in a printing-disabled document file, the user can easily know printing permission information of the printing-permitted pages by only seeing the screen 1601. Even for such a document, the user can know by a simple operation that a printing-permitted portion still remains, and can effectively use image contents. Also, this can reduce the possibility that the user may miss the opportunity to print these image contents because printing of even a printing-permitted portion will be inhibited.

Even in the fourth embodiment, the OS may implement some or all of the above-described functions. The file list application 1051 and preview generation module 1031 may be integrated. Printing permission information of a document may be composited with an icon image indicating not document contents but only the type, and displayed. Only printing permission information may be displayed together with a file name. As printing permission information of a document, only either the printing permission remaining count or printing permission remaining period may be displayed. If it is determined in step S1708 that there is a printing-permitted page, it is also possible to add a warning mark to image data, printing of which is determined to be inhibited, and display a page containing the image data as a thumbnail, similar to the first embodiment. As the notification method, various methods are available.

Even in the fourth embodiment, the content database 222 may reside in another information processing apparatus capable of communicating with the PC 100 via a network (not shown). A single apparatus may have both the function explained with reference to FIGS. 10, 13, and 14, and a function of printing on a printing medium such as printing paper. The content may be one other than image data.

In various embodiments described above, when printing print data containing a plurality of contents, it can be determined whether printing of each content is permitted, and the user can be notified of whether printing is permitted, before an instruction to print the print data. If the user designates printing in response to this notification, printing of the print data is executed. Also when printing the same print data next time, the user is notified whether printing is permitted. In the above description, when printing of all contents contained in one print data (document file) is permitted, printing of the print data is permitted. However, a printing-disabled content may be replaced with, for example, a blank or another data to print. The user may be notified whether printing is permitted when he issues a printing instruction. That is, if print data contains a printing-disabled content when the user issues a printing instruction, he may be notified of this, similar to the first and second embodiments.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-162211, filed Jul. 16, 2010, which is hereby incorporated by reference herein in its entirety.

What is claimed is:

1. An information processing apparatus which processes print data to be printed by a printing apparatus, comprising:
an input unit configured to input print data containing a plurality of contents;
a determination unit configured to determine whether printing of each of the plurality of contents contained in the print data input by said input unit is permitted; and
a notification unit configured to notify a user of a result of a determination by said determination unit before the print data is instructed to print.

2. The apparatus according to claim 1, wherein said determination unit determines whether printing of each of the plurality of contents contained in the print data input by said input unit is permitted, by referring to information managed by a management unit configured to manage information containing at least one of a print processing permission remaining count and a time limit for each of the plurality of contents.

3. The apparatus according to claim 1, wherein when the plurality of contents contained in the print data input by said input unit contain a content, printing of which is determined by said determination unit not to be permitted, said notification unit notifies the user of the printing-disabled content identifiably.

4. The apparatus according to claim 3, further comprising a layout display unit configured to display a layout of the print data input by said input unit,
wherein said notification unit displays, on the layout displayed by said layout display unit, information capable of identifying the content, printing of which is determined by said determination unit not to be permitted.

5. The apparatus according to claim 2, wherein said notification unit notifies the smallest remaining count or the earliest time limit, out of remaining counts and time limits of the plurality of contents contained in the print data input by said input unit.

6. A display control method executed in an information processing apparatus which processes print data to be printed by a printing apparatus, comprising the steps of:
inputting print data containing a plurality of contents;
determining whether printing of each of the plurality of contents contained in the input print data is permitted; and
notifying a user of a result of the determination before an instruction to print the print data.

7. A non-transitory computer-readable storage medium storing a program for causing a computer to
input print data containing a plurality of contents,
determine whether printing of each of the plurality of contents contained in the input print data is permitted, and
notify a user of a result of the determination before an instruction to print the print data.
